(19) United States
(12) Patent Application Publication
(10) Pub. No.: US 2010/0108671 A1
(43) Pub. Date: May 6, 2010

(54) Pressure Relief System

(76) Inventor: William Cho, Reno, NV (US)

Correspondence Address: IAN F. BURNS & ASSOCIATES, 4790 Caughlin Parkway #701, RENO, NV, 89519-0907, US

(21) Appl. No.: 12/612,551

(22) Filed: Nov. 4, 2009

Related U.S. Application Data
(60) Provisional application No. 61/111,250, filed on Nov. 4, 2008.

(51) Int. Cl. B65D 90/36; B29C 65/00

(52) U.S. Cl. 220/89.2; 156/196

(57) ABSTRACT

A pressure relief system including a container having (a) at least two layers sealed together to form a closed cavity and (b) a stress point area is disclosed. The stress point area is configured to rupture upon sufficient pressure being generated in the closed cavity so that venting of pressurized contents of the container cavity may occur without explosive bursting of the container.

### CROSS REFERENCES TO RELATED APPLICATIONS

This application claims priority to U.S. provisional patent application No. 61/111,250, filed Nov. 4, 2008. The above referenced application is hereby expressly incorporated by reference in its entirety.

### BACKGROUND OF THE INVENTION

The present invention relates to a pressure relief system for use in material packaging systems, particularly food packaging methods where packaged foods may be heated prior to consumption.

Typically, packaged frozen or chilled foods have been prepared by freezing and sealing the foods in package containers, such as bags or containers having a base and cover. The packaged foods may then be stored frozen for subsequent transportation or storage. The frozen foods are then heated and/or cooked by conventional means, for example, ovens, particularly microwave ovens. Some food storage bags may have closure mechanisms, such as zipper elements or slidable clamps that allow for resealable access to food contents.

However, many of these food storage bags/containers do not allow for heating or microwaving of food products in the sealed condition since internal pressures developed during heating/cooking generates pressure from vaporization of liquid components in the frozen foods, potentially causing the storage container to explosively burst.

There is a need for improved food packaging systems (1) without complex valve systems or complex resin system components that may contaminate the packaged food materials and (2) that allow controlled venting of internal pressures when frozen packaged foods are cooked or heated, such as in microwave ovens.

### BRIEF SUMMARY OF THE INVENTION

In one embodiment of the present invention, a pressure relief system is provided that includes a container comprising at least a first layer and a second layer, wherein the first layer and the second layers are configured to provide a closed cavity, the closed cavity being configured to hold a substance, typically a food material; and a stress point area located apart from an edge seam of the container and formed by bonding of the first and second layers, wherein the stress point area is shaped to produce stress on a portion of the stress point area, allowing the stress point area to rupture to relieve pressure within the closed cavity when sufficient pressure is provided within the cavity.

In another embodiment, the present invention provides a method for manufacturing a pressure relief system for packaged foods including, but not necessarily in order shown: (a) providing at least a first layer and a second layer of flexible material; (b) bonding at least the first layer to the second layer along at least one edge seam to form a container having a closed cavity formed therein; (c) forming a stress point area in a region located apart from any edge seam of the container by bonding the first layer to the second layer; and (d) configuring and shaping the stress point area to provide stress on a portion of the stress point area that allows the stress point area to rupture to relieve pressure within the closed cavity when sufficient pressure is provided within the cavity.

The various embodiments of the present invention may, but not necessarily, achieve one or more of the following advantages:

provide a food packaging system without complex valve components;

provide a food packaging system without relying on complex resin components that may contaminate the packaged food materials;

the ability to allow controlled venting of internal pressures when frozen packaged foods are cooked or heated;

provide selected ridge/groove configurations for the stress point area that selectively allow rupture under low pressure conditions that would otherwise require higher pressure conditions compared to the use of other packaging surface configurations; and

provide selected positioning for the stress point area that achieves various results, for example, cooking different kinds of food or cooking the same food to different heating levels.

These and other advantages may be realized by reference to the remaining portions of the specification, claims and abstract.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

Typical embodiments are shown in the accompanying drawings wherein:

FIG. 1 is substantially a top view of a pressure relief system of the present invention.

FIG. 2 is substantially a side cross-sectional view of a pressure relief system of the present invention taken along line A of FIG. 1.

FIG. 3 is substantially a top view of one embodiment of the present invention involving a circular stress point area.

FIG. 4 is substantially a top view of one embodiment of the present invention involving a star-shaped stress point area.

### DETAILED DESCRIPTION OF THE INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

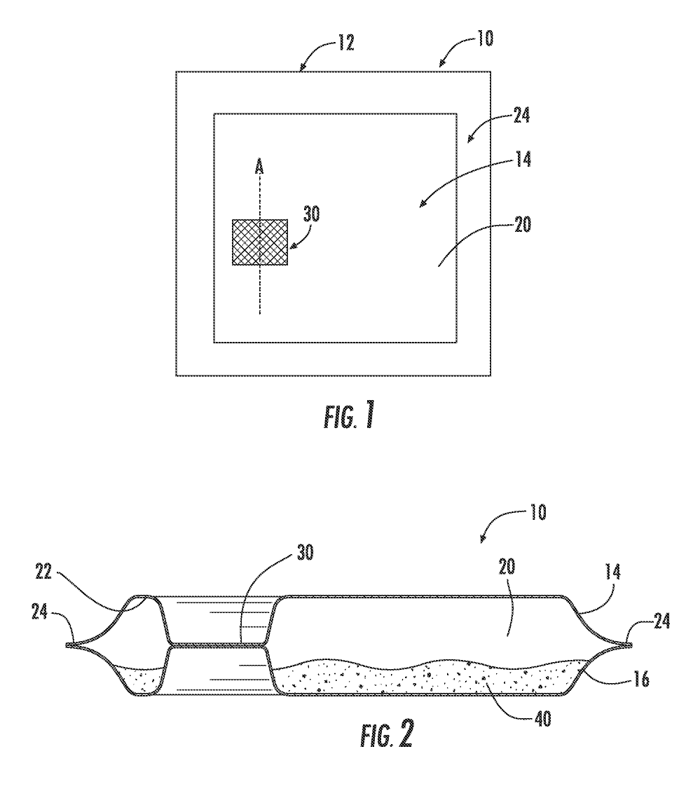

As shown in FIGS. 1 and 2, one embodiment of the present invention involves a pressure relief system indicated by reference number 10. Pressure relief system 10 comprises a container 12 that may be formed from a first layer 14 and a second layer 16. Container 12 may comprise a large variety of shapes and sizes. For example, container 12 may comprise polygons, curved shapes and three dimensional shapes.

First layer 14 and second layer 16 may comprise a flexible material which may be the same or different in the separate layers 14 and 16. In one embodiment, suitable flexible materials may be in the form of layers or films, and include, for example, polyester, nylon, polyethylene, polypropylene, paper, foil, polyester or nylon laminated to (or co-extruded with) polyethylene or polypropylene, and combinations thereof.

Container 12 comprises a cavity 20 formed by an inner wall 22. Cavity 20 is configured to hold a substance 40, such as food. First layer 14 and second layer 16 may be bonded together to form cavity 20 in between the layers 14 and 16. In one embodiment, an edge seam 24 may be formed in an area where first layer 14 and second layer 16 are bonded together. The bonding may be performed in a number of different ways, such as by applying heat and pressure, adhesives or a combination thereof, for example.

In one embodiment, container 12 may be formed by a single sheet of flexible material. In this embodiment (not shown), the flexible material is folded upon itself and its edges are bonded together to form cavity 20, for example, the layers 14 and 16 of FIG. 2 would be of the same material.

Typically, the stress point area is positioned in a location configured to provide a predetermined pressure within the closed cavity before the stress point area ruptures. The stress point area is located substantially within the closed cavity of the container. For example, the stress point area may be positioned substantially in a middle portion of the closed cavity.

In another embodiment (not shown), one portion of container 12 may be formed from a more rigid flexible material. The more rigid material may be a thicker layer of the suitable flexible materials, such as those listed above. The more rigid material may be formed to provide a receptacle with an opening defined by a rim. The opening may be covered by bonding a flexible material to the rim. The container may be a vacuum bag of a type that is well known in the art and marketed under the trademark FoodSaver®.

Pressure relief system 10 further comprises a stress point area 30. Stress point area 30 may be provided adjacent to seam 24 or it may be spaced apart from the seam (as shown in FIG. 1). In one embodiment, stress point area 30 is positioned at or near a middle portion of cavity 20 (not shown in FIGS. 1 and 2). Stress point area 30 may comprise a bonded area where first layer 14 is bonded to second layer 16. Stress point area 30 has a shape and size to produce a stress on a portion of the bonded area. Suitable shapes for stress point area 30 may include rectangular (square-like, for example), diamond, circular, semicircular, chevron (V-shaped), triangular and star configurations, for example. When a sufficient stress is placed on a portion of the bonded area of stress point area 30, the material around stress point area 30 ruptures, thereby releasing pressure within cavity 20.

In one embodiment, stress point area 30 comprises a roughened or knurled surface that has a plurality of ridges and grooves. Without being bound by theory, it is believed that the ridges and grooves of the knurled surface tend to provide areas that are selectively weakened allowing stress point area 30 to rupture under lower pressure conditions than would otherwise be required if stress point area 30 were configured as another type of surface, such as a flattened surface, for example. Stress point area 30 may be formed using the same bonding process by which container 12 is formed.

In an alternative embodiment, stress point area 30 may be formed after container 12 is formed. For example, stress point area 30 may be formed by the end user just prior to heating container 12 or just prior to placing a food substance into container 12 for storage. This may be performed by using a small clamping tool that holds first layer 14 and second layer 16 together and then heating the clamped area. Other bonding methods, such as sonic welding, may also be used. The clamping portion of the clamping tool may be in the shape of stress point area 30 and it may have a heating element incorporated into it.

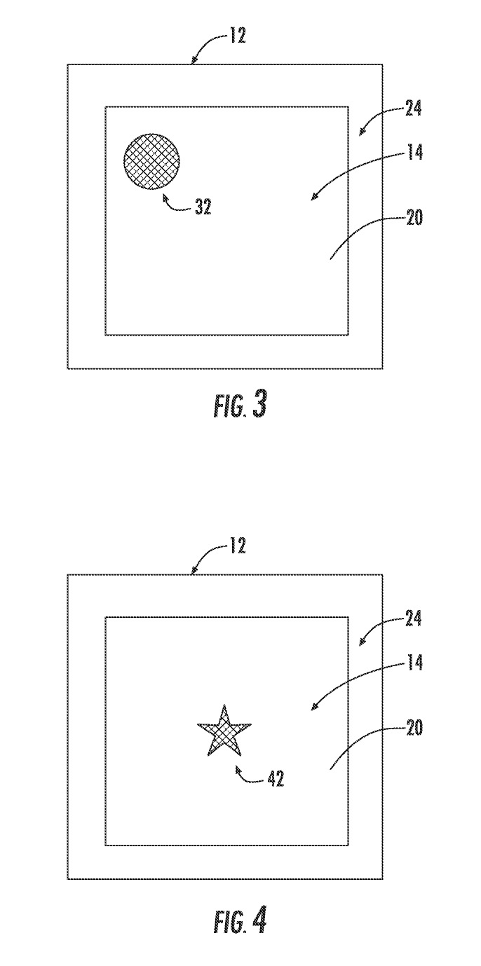

Stress point area 30 may be positioned or shaped to respond to, or accommodate, a predetermined pressure in cavity 20. Different positions and shapes may be used to be responsive to different desired internal pressures of closed cavity 20. For example, a round stress point area 32 placed at a corner portion of container 12 may not rupture until a relatively high pressure is reached (shown in FIG. 3) whereas a star-shaped stress point area 42 placed near a middle portion of the container may rupture at a lower pressure (shown in FIG. 4). The location and shape of stress point area 30 may be selected by the user to achieve different results, for example, cooking different kinds of food or cooking the same food to different levels.

In another embodiment, a perforation or hole (not shown in FIGS. 1-4) may be provided in stress point area 30 to produce an area of relatively low strength that may rupture when stressed sufficiently.

When pressure builds up in cavity 20, the stress from the pressure causes stress point area 30 to fail or break. A gas, such as vaporized moisture, may then pass through the stress point, thereby venting pressure from the cavity. For example, the present invention may be incorporated in a food bag. Food substance 40 is placed in the container and the container is sealed using any of a variety of the bonding procedures: sonic welding, applying heat, pressure, adhesives or combinations thereof, for example. The food bag may then be placed in a freezer or refrigerator for storage. When a user wishes to eat the food, the food bag may be placed in a microwave oven for heating. As the food is heated, pressure in the food bag increases as moisture from the food vaporizes. In prior art food bags, the increased pressure may cause the food bag to explode. However, the pressure relief system of the present invention prevents an explosion from occurring by venting the water vapor in a controlled manner due to the construction of the stress point area of the container.

Although the description above contains many specifications, these should not be construed as limiting the scope of the invention but merely as providing illustrations of some of the embodiments of this invention. Thus, the scope of the invention should be determined by the appended claims and their legal equivalents rather than by the examples given.

We claim:

1. A pressure relief system comprising:
A) a container comprising at least a first layer and a second layer, wherein the first layer and the second layers are configured to provide a closed cavity, the closed cavity being configured to hold a substance; and
B) a stress point area located apart from an edge seam of the container and formed by bonding of the first and second layers, wherein the stress point area is shaped to produce stress on a portion of the stress point area, allowing the stress point area to rupture to relieve pressure within the closed cavity when sufficient pressure is provided within the cavity.

2. The pressure relief system of claim 1 wherein first and second layers are bonded to each other along at least one edge seam of the container to form the closed cavity.

3. The pressure relief system of claim 2 wherein the stress point area comprises a knurled surface configuration including a plurality of ridges and grooves.

4. The pressure relief system of claim 2 wherein the stress point area comprises a shape selected from one or more of circular, rectangular, diamond, semicircular, triangular, star and chevron configurations.

5. The pressure relief system of claim 1 wherein the stress point area comprises a knurled surface configuration including a plurality of ridges and grooves.

6. The pressure relief system of claim 5 wherein the stress point area is positioned substantially within the closed cavity of the container.

7. The pressure relief system of claim 5 wherein the stress point area is positioned substantially in a middle portion of the closed cavity.

8. The pressure relief system of claim 1 wherein the stress point area is positioned in a location configured to provide a predetermined pressure within the closed cavity before the stress point area ruptures.

9. A method of manufacturing a pressure relief system for packaged foods comprising, but not necessarily in order shown:
(A) providing at least a first layer and a second layer of flexible material;
(B) bonding at least the first layer to the second layer along at least one edge seam to form a container having a closed cavity formed therein;
(C) forming a stress point area in a region located apart from any edge seam of the container by bonding the first layer to the second layer; and
(D) configuring and shaping the stress point area to provide stress on a portion of the stress point area that allows the stress point area to rupture to relieve pressure within the closed cavity when sufficient pressure is provided within the cavity.

10. The method of claim 9 further comprising configuring and shaping the stress point area to provide a plurality of ridges and grooves to form a knurled surface.

11. The method of claim 9 further comprising forming the stress point area in a shape selected from one or more of circular, rectangular, diamond, semicircular, triangular, star and chevron configurations.

12. The method of claim 9 further comprising forming the stress point area in a middle portion of the closed cavity.
